(19) United States
(12) Patent Application Publication
(10) Pub. No.: US 2011/0076506 A1
(43) Pub. Date: Mar. 31, 2011

(54) LAMINATE STRUCTURES

(75) Inventors: Robert Jacob Blok, Hilversum (NL); Jørn Erland Olsen, Heggedal (NO)

(73) Assignee: Elopak Systems AG, Glattbrugg (CH)

(21) Appl. No.: 12/735,749

(22) PCT Filed: Feb. 12, 2009
(86) PCT No.: PCT/EP2009/051670

§ 371 Date: Nov. 4, 2010

(30) Foreign Application Priority Data
Feb. 15, 2008 (GB) 0802813.6
Apr. 25, 2008 (GB) 0807582.2

(51) Int. Cl. B32B 27/34; B32B 27/32; B32B 27/06; B32B 37/12; B32B 37/16

(52) U.S. Cl. 428/474.4; 428/476.9; 428/474.7; 428/523; 156/244.21; 156/306.6

(57) ABSTRACT

A method of producing a laminate structure comprises producing a multi-layer barrier film by producing a blown film of n-layers, by a blown extrusion process and subsequently collapsing the n-layer blown film to form the multi-layer barrier film, which consists of 2n-layers and which comprises a first polymer layer, a gas barrier layer and a second polymer layer, wherein at least one of the first and second polymer layers comprises a polyamide layer, providing the outside of a substrate with a polymer layer, and extrusion laminating the multi-layer barrier film to the inside of the substrate by an adhesive layer. In one embodiment, the first polymer layer, the gas barrier layer and the second polymer layer form a first barrier block, and the multi-layer barrier film further comprises a second barrier block, substantially identical to the first barrier block.

This invention relates to laminate structures and methods of making the same.

United States of America Patent Application Publication U.S. 2003/0180489 discloses a non-foil barrier laminate structure. Containers constructed from the barrier laminates disclosed therein can be hot filled or cold filled and can be stored at either ambient conditions or refrigerated conditions. The laminate structures progressing inwardly have a polyamide layer for mechanical strength and thermal resistance; a first EVOH layer as a barrier to oxygen ingress applied in direct contact with the polyamide layer and a second barrier layer of EVOH, nylon or the like positioned closer to the contact surface of the product that may act as a barrier to oxygen, water vapour, flavour/aroma, or a combination, which is not in contact with the first oxygen barrier layer of EVOH, and layers of polyolefin on both the matte side (interior) and the gloss side (exterior) of the laminate for heat sealing. The laminate structures of that Publication are all provided with the polyamide layer applied directly on the paperboard substrate in a coating process. This results in a production line that is relatively inefficient, when changes need to be made to the materials that are being laminated onto the substrate.

It is therefore an object of the invention to improve upon the known art.

According to a first aspect of the present invention, there is provided a method of producing a laminate structure comprising
producing a multi-layer barrier film by producing a blown film of n layers, by a blown extrusion process, and collapsing the n-layer blown film to form the multi-layer barrier film, which consists of 2n layers, and which comprises a first polymer layer, a gas barrier layer and a second polymer layer, wherein at least one of the first and second polymer layers comprises a polyamide layer,
providing a substrate, and
laminating the multi-layer barrier film to the substrate.

According to a second aspect of the present invention, there is provided a laminate structure comprising, from the outside to the inside,
a substrate, and
a multi-layer barrier film comprising a 2n-layers film consisting of an n-layer blown film collapsed, the film including a first polymer layer, a gas barrier layer and a second polymer layer, wherein at least one of the first and second polymer layers comprises a polyamide layer.

According to a third aspect of the present invention, there is provided a laminate structure comprising, from the outside to the inside,
a substrate, and
a multi-layer barrier film comprising a first polymer layer, a gas barrier layer and a second polymer layer, wherein at least one of the first and second polymer layers comprises a polypropylene layer.

According to a fourth aspect of the present invention, there is provided a method comprising, at a laminating station on a production line for a laminate structure, laminating together (i) a multi-layer barrier film comprising a first polymer layer, a gas barrier layer and a second polymer layer, wherein at least one of the layers comprises a polyamide, and (ii) a substrate, and, subsequently, laminating together at said station a substrate and another multi-layer barrier film differing from the first-mentioned film.

Owing to these aspects of the invention, it is possible to provide a low flavour-scalping laminate structure for use in creating a container for liquid food products. The method of producing the structure using a multi-layer barrier film allows shorter runs on a production line without greatly affecting the overall efficiency of the production line, as different barrier films can be used at different times. There is no need to purge extruders, which is a lengthy process, which is required when changing the layers used to produce a laminate in a coating production line. A more flexible production solution is provided as a result.

The lamination may take the form of thermal lamination, by heating that surface layer of the multi-layer barrier film which is to contact the substrate, thereby to render that surface layer tacky prior to application thereof to the substrate. Preferably, however the multi-layer barrier film is extrusion laminated to the substrate by way of an adhesive layer.

In the event that the substrate is paperboard or another moisture-absorbent material, it preferably has on the outside thereof an outer layer of a substance which is a barrier to moisture. This outer layer may be extrusion-coated onto the substrate or be the innermost layer of a multi-layer barrier film laminated to the substrate either by thermal lamination, or preferably, by extrusion lamination.

Preferably, the first polymer layer, the gas barrier layer and the second polymer layer form a first barrier block, and the multi-layer barrier film further comprises a second barrier block, substantially identical to the first barrier block, whereby there can be two barrier blocks in the multi-layer film, one of which will be relatively closer to the liquid food contents in the ultimate container to provide optimal scalping properties, and the other of which will be relatively closer to the substrate (such as paperboard) to provide oxygen barrier properties. The layer distribution of the components of the barrier blocks provides a better barrier structure with greater consistency.

Advantageously, the gas barrier layer comprises an EVOH layer, and each of the first and second polymer layers comprises a polyamide layer. The layer which comprises EVOH (ethylene vinyl alcohol), which has excellent gas and odour barrier properties, is provided with improved flex-crack resistance, by the provision of the polyamide (nylon) layer on one or both sides of the EVOH. In the preferred embodiment, the first polymer layer (polyamide) contacts the gas barrier layer (EVOH) and the gas barrier layer (EVOH) contacts the second polymer layer (polyamide). Alternatively, one of the first and second polymer layers can comprise a polypropylene layer. As an alternative to the polyamide on both sides of the gas barrier EVOH, one side of the EVOH can be a layer of polypropylene.

The film of n-layers is blow extruded as a single co-extrusion, and then bubble collapsed in on itself while the internal polymer layer is still hot, in order to form the barrier film that is twice the thickness of the original blown film, i.e. 2n-layers, with each layer repeated twice in the final barrier film. The internal layer welds to itself as the bubble collapses, forming a seal.

The use of a blown film that is collapsed in on itself to form the barrier film has a number of advantages. Firstly, it provides an efficient solution to the provision of two barrier blocks in the barrier film, as the layers in the blown film are duplicated in one step, when forming the barrier film. Blowing the film provides good mechanical strength for the layers within the film, as the polymers will be bi-axially oriented in each layer, providing a good strength solution for a given weight of a layer. In addition, the blown film process provides good ventilation of the film as it is being manufactured (as air is circulated inside and outside the film prior to collapse, which helps to remove low molecular weight (volatile) components from the film. The removal of these components prevents them from adversely affecting the flavour and odour properties of the ultimate liquid food contents of a container made using the laminate structure that includes the barrier film, as otherwise these components can migrate into the product. Additionally, the production of the blown film can be carried out offline, separately from the main production line that is producing the laminate structure. Different barrier films can be swapped in and out of the production line with very little downtime compared to a normal change in extruders in a coating line.

A preferred example of a value of n within the blown film is n=7. In this case, the n-layer blown film comprises, from the outside to the inside, a polymer layer, a tie layer, the first polymer layer which comprises a polyamide layer, the gas barrier layer which comprises an EVOH layer, the second polymer layer which comprises a polyamide layer, a tie layer and a polymer layer. This film is extrusion laminated onto the substrate with an adhesive layer to create the finished laminate structure.

Embodiments of the present invention will now be described, by way of example only, with reference to the accompanying drawings, in which:

FIG. 1 is a schematic diagram of a production line,

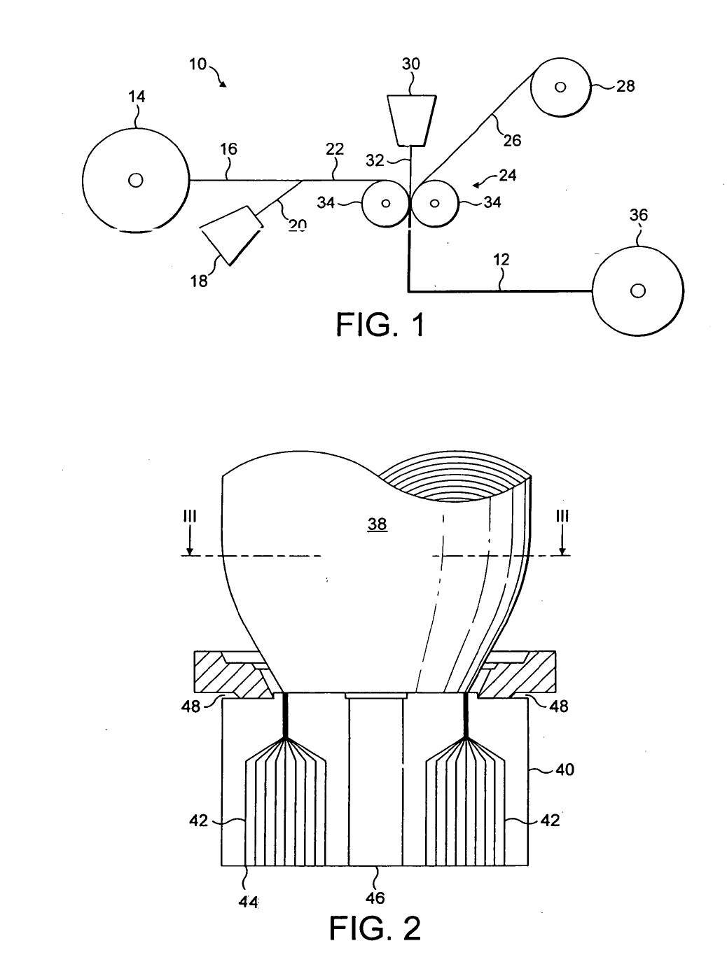

FIG. 2 is a partial cross-section of a device for producing a blown film,

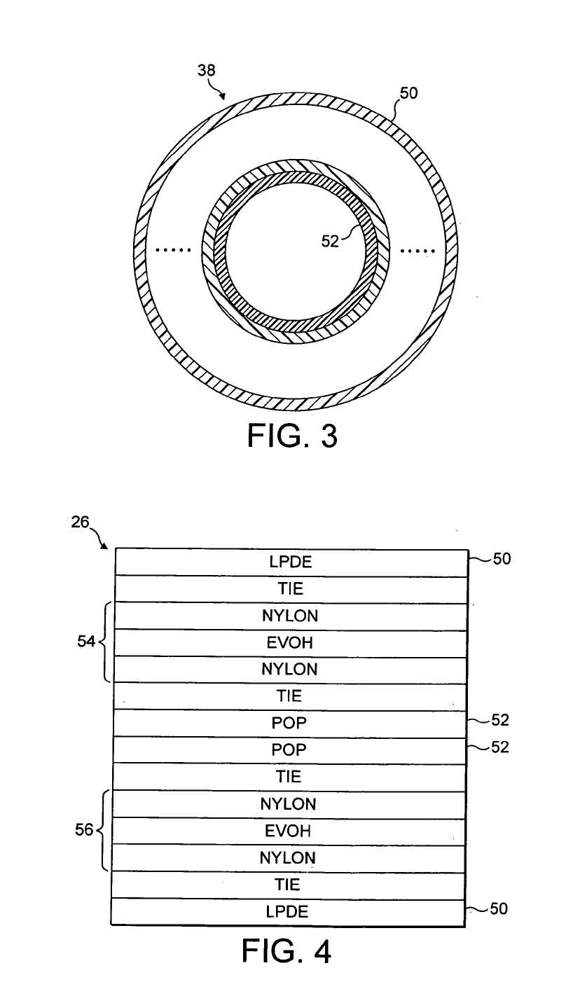

FIG. 3 is a partial cross-section, on the line III-III of FIG. 2, through the blown film produced by the device of FIG. 2,

FIG. 4 is a schematic diagram of the multi-layer barrier film produced from the blown film of FIG. 3, and

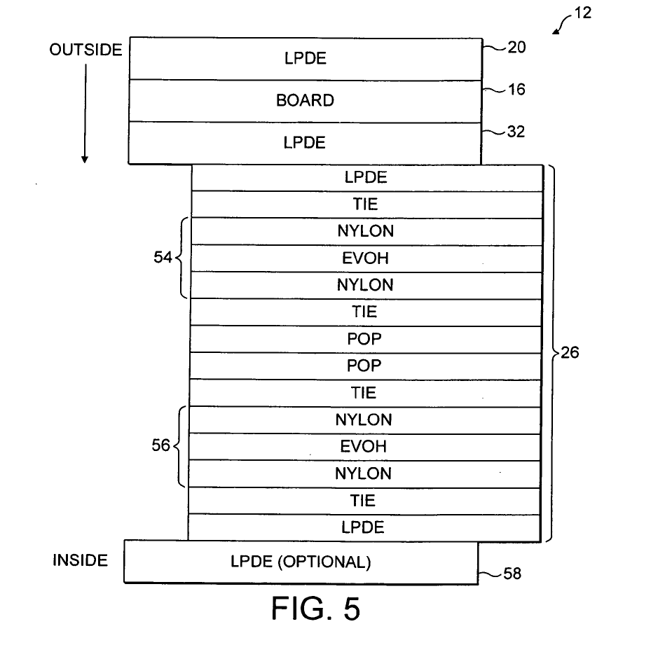

FIGS. 5 to 12 are schematic diagrams of different embodiments of a laminate structure.

FIG. 1 shows a production line 10 for producing a laminate structure 12. A roll 14 of paperboard 16 is used to provide a substrate for the laminate structure 12. A coating station 18 is provided to coat the outside of the substrate 16 with a polymer layer 20 (such as LDPE) from an extruder, and this coated substrate 22 is passed to a station 24 where the coated substrate 22 is extrusion laminated with a multi-layer barrier film 26 fed from a roll 28. The stations 18 and 24 may include up to nine extruders linked with a feedblock with a corresponding number of dies. In this way, for example, the polymer layer 20 may comprise a plurality of sub-layers forming a more complex laminate structure. For example, a plurality of extruders at the station 18 could be configured to coat a polymer layer structure 20 onto the paperboard 16, such a polymer layer structure comprising sub-layers and being of the same or similar composition as the multi-layer barrier film 26 (as described below). Alternatively, the coating taking place at the station 18 could be in the form of extrusion laminating involving the coating of the outside of the substrate 16 with, for example, a second multi-layer film, identical or similar to the film 26.

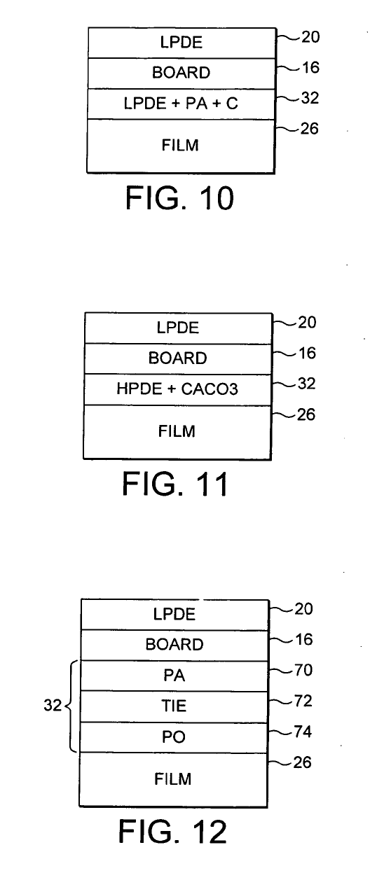

An extruder 30 at the station 24 provides an adhesive layer 32 (such as LDPE) onto the inside of the coated substrate 22 which adheres the film 26 to the coated substrate 22, as it is passed between a pair of rollers 34. The final laminate structure 12 is wound onto a roll 36. At the extrusion lamination station 24, as shown in FIG. 1, the film 26 is laminated to the coated substrate 22 using a single layer 32, but the extruder 30 could be configured to extrude multiple layers, and thereby provide a more complex laminate structure (see FIGS. 10 to 12).

Part of the production of the multi-layer barrier film 26 is shown in FIG. 2. In this Figure, a blown film 38 is produced. The device for producing the blown film 38 includes a die 40 which is cylindrical (shown in FIG. 2 in section) which, in this example of the device includes nine concentric channels 42. Different dies 40 can be used, depending upon the number of layers that are desired in the blown film 38. The channels 42 are used to introduce different molten polymer materials 44, which are used to produce the blown film 38. The materials 44 flow upwards under pressure, which is normally in the range of 200 to 600 bar. Air is introduced via a central shaft 46 into a chamber (not shown) that contains the blown film 38, the air being supplied to inside the tubular film 38. Further channels 48 also introduce air into the chamber but outside the film 38.

FIG. 3 shows a partial cross-section of the blown film 38. The layers in the blown film 38 are effectively concentric rings corresponding to the materials 44 in the channels 42 of the die 40. Only three layers are shown (not to scale) for ease of understanding. The outermost layer 50 is cooled by the air introduced by the channels 48, and is adjacent the wall of the chamber of the blown film apparatus. The innermost layer 52 is cooled by the air from the shaft 46 which is circulated in the bubble formed by the blown film 38.

As discussed above, the step of producing the multi-layer barrier film 26 comprises producing a blown film 38 of n layers, by a blown extrusion process. After the blown film 38 is produced, the process of producing the multi-layer barrier film 26 further comprises collapsing the n-layer blown film 38, between a pair of rollers (not shown), to form the multi-layer barrier film 26, the multi-layer barrier film 26 consisting of 2n layers. An example of the finished barrier film 26 is shown in FIG. 4, where n=7. This is the preferred embodiment of the invention, in which a seven layer blown film 38 is collapsed into a fourteen layer barrier film 26. The innermost layer 52 of the original blown film 26 is brought together by the action of the rollers and kept sufficiently hot that the layer 52 welds to itself. The layer 52 comprises a polyolefin plastomer (POP).

Other methods of producing the barrier film 26 are possible, such as using a cast co-extrusion process to create the multi-layer barrier film 26. The layers of the barrier film do not have to be all formed in one process. For example, if a 14 layer film is desired, then a 7 layer film can be produced and this could be extrusion laminated to the coated substrate 22 twice to give the required number of layers.

In the preferred embodiment, the n-layer blown film 38 comprises, from the outside to the inside, a polymer layer, a tie layer, the first polymer layer comprising a polyamide (nylon) layer, the gas barrier layer comprising an EVOH layer, the second polymer layer comprising a polyamide layer, a tie layer and a polymer layer. Once this is collapsed to form the barrier film 26 then these layers are repeated. This process provides a multi-layer barrier film 26 which comprises a first polymer layer (polyamide), a gas barrier layer (EVOH) and a second polymer layer (polyamide), wherein both of the first and second polymer layers comprise a polyamide layer.

The first polymer layer, the gas barrier layer and the second polymer layer form a first barrier block 54, and the multi-layer barrier film further comprises a second barrier block 56, substantially identical to the first barrier block 54. In the barrier film 26, the first polymer layer contacts the gas barrier layer and the gas barrier layer contacts the second polymer layer. In the preferred embodiment, the gas barrier layer comprises an EVOH layer.

The completed barrier film 26 is extrusion laminated to the substrate 16, as described above with reference to FIG. 1. An example of the finished laminate 12 is shown in FIG. 5, which is produced using the barrier film 26 shown in FIG. 4. An additional (but optional) product-contacting layer 58 of LDPE is provided on the inside of the laminate structure 12, which is coated onto the film 26 side of the laminate, in a conventional fashion. The barrier film 26 is shown offset from the other layers of the laminate 12, purely for illustrative purposes, and in a finished product will be aligned with the other layers that make up the laminate structure 12. As mentioned above, a second multi-layer barrier film substantially identical to the film 26 and produced in substantially the same way can be extrusion laminated onto the outside of the paperboard substrate 16 in place of the polymer layer 20.

Each of the barrier blocks 54 and 56 in the laminate structure 12 performs a different function. The first barrier block 54 is located relatively closer to the paperboard substrate 16, and performs an oxygen barrier function in the laminate 12. The second barrier block 56 is located relatively closer to the ultimate liquid food contents of the eventual container formed from the laminate structure 12. This second barrier block provides an anti-scalping function in the laminate structure 12, preventing flavour and odour components from leaching into the laminate structure 12 from the liquid food contents.

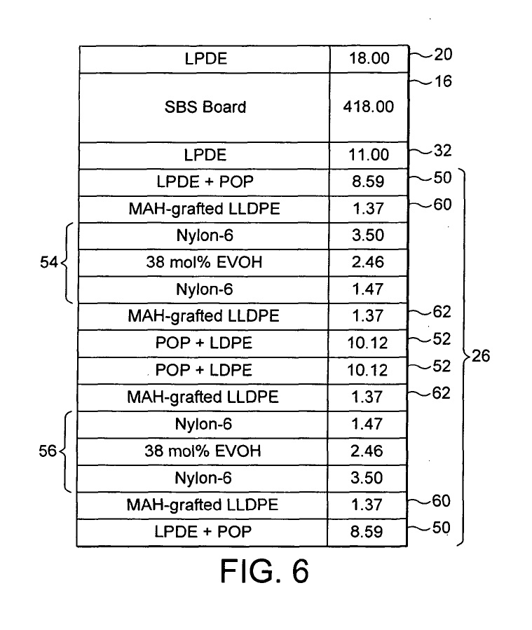

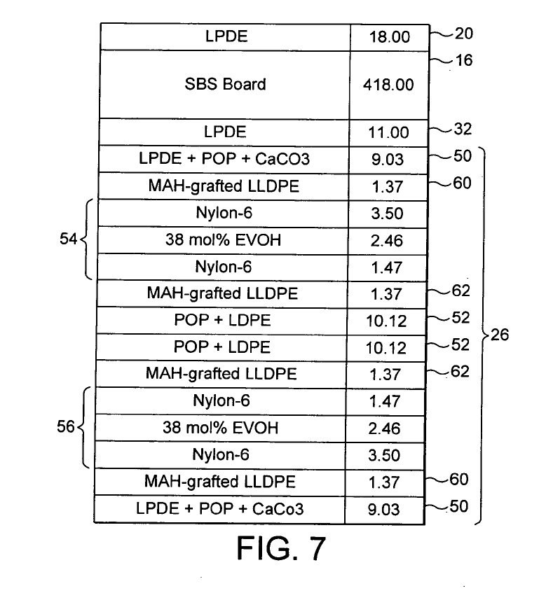

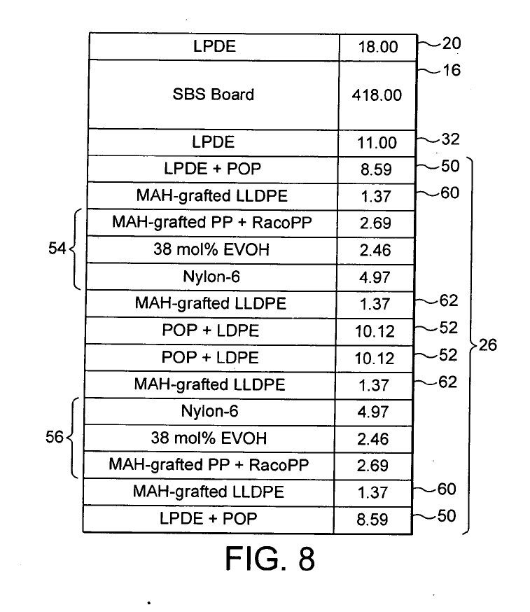

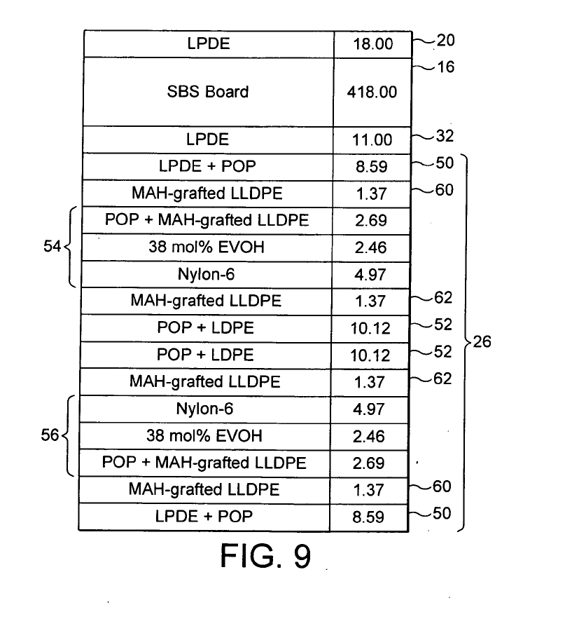

FIGS. 6 to 9 show further embodiments of the laminate structure 12. Each layer in the laminate structure 12 in these Figures is provided with a weight in grams per square metre, of the respective layer. The table below shows further details of the weights of the laminate structures 12 in each of FIGS. 6 to 9. The top row of weights in the table is the overall gr/m² of the respective laminate structures 12, the second row is the overall weight of the multi-layer barrier film 26 plus the adhesive layer 32, the third row is the weight of the outer polymer layer 20, the fourth row is the total weight of all of the polyamide (nylon) layers, and the fifth row is the total weight of all of the gas barrier (EVOH) layers.

| | FIG. 6 | FIG. 7 | FIG. 8 | FIG. 9 |
|---|---|---|---|---|
| total gr/m² | 504.8 | 505.6 | 510.1 | 510.1 |
| inside coating gr/m² | 68.8 | 69.6 | 74.1 | 74.1 |
| outside coating gr/m² | 18.0 | 18.0 | 18.0 | 18.0 |
| nylon total gr/m² | 9.9 | 9.9 | 9.9 | 9.9 |
| EVOH total gr/m² | 4.9 | 4.9 | 4.9 | 4.9 |

The FIG. 6 embodiment, from outside to inside comprises, a layer of LDPE 20, the paperboard substrate 16, the adhesive layer of LDPE 32, and then the fourteen layer barrier film 26, which is formed by collapsing a seven layer blown film 38. The layers of the blown film 38, from the outside to the inside comprise an outer layer 50 of LDPE and polyolefin plastomer (POP), a tie layer of MAH-grafted LLDPE (linear low density polyethylene) 60, then the barrier block 54 consisting of a layer of aliphatic nylon, a layer of 38 mol% EVOH, and a second layer of nylon, a second tie layer of MAH-grafted LLDPE 62, and an inner layer 52 of polyolefin plastomer (POP) and LDPE. The remainder of the fourteen layer barrier film 26 is made up of the above seven layers in reverse order.

The embodiment of FIG. 7 differs from the embodiment of FIG. 6 only in that the outer layer 50 of the barrier film 26 further comprises CaCO₃ (calcium carbonate) which provides good heat resistance during the container forming process, and the nylon within the film 26 is nylon-6. As a result of these differences the weight of this layer is slightly increased, from 8.59 gr/m² in FIGS. 6, to 9.03 gr/m² in FIG. 7.

The embodiment of FIG. 8 differs from the embodiment of FIG. 6 in that one of the first and second polymer layers of the barrier block comprises a polypropylene layer, which replaces the nylon layer. Polypropylene has the advantage that it is even more flex crack resistant than polyamide. The outer layer of the barrier block is MAH-grafted polypropylene and Raco (Random Copolymer) polypropylene. To compensate for the loss of the nylon in this layer, the other nylon layer in the barrier block is enlarged, from 1.47 gr/m² in FIGS. 6, to 4.97 gr/m² in FIG. 8, to give the same overall weight of nylon in the laminate structure 12. The use of a polypropylene layer within the laminate structure further improves the flex-crack resistance of the overall structure, and gives further strength to the gas barrier layer of EVOH, to which the polypropylene is adjacent.

The embodiment of FIG. 9 differs from the embodiment of FIG. 8 in that the outer layer of the barrier block that is polypropylene in FIG. 8 is replaced with a tie layer of polyolefin plastomer (POP), which is a high-strength material with a good degree of flexibility, and MAH-grafted LLDPE.

The outer layers 50 shown in the embodiments of FIGS. 6, 8 and 9 may have the POP replaced by an anti-blocking agent, for example an inorganic silica additive, which modifies the surface of the LDPE with which it is blended in order to improve the interface characteristics with adjacent layers.

The new production line 10 of FIG. 1 is able to run existing structures but also the new barrier structure 12. The new line 10 eliminates some of the inefficiencies of the existing lines, and the new line 10 is able to run more productive hours per year, resulting in better yields. The new barrier structure 10, as well as existing structures, are optimised as to usage of expensive high barrier resins (like EVOH) and co-extrudable adhesives (tie layers) by substantially better profile control allowing down gauging.

Instead of using a complicated line equipped with several multi-layer coating stations, the production line 10 is better through being a relatively simple (cheaper) high speed line that is able to run the normal standard LDPE-based coating structures but is also able to extrusion laminate the off-line made barrier film 26 in the coating structure.

The line 10 can be a simple two-station, high-speed state of the art coating line with gravimetric blending and throughput control with investment in a 2.4 metre wide, 7-layer state of the art high output blown co-extrusion line to be able to manufacture the 20 to 35 microns high-barrier, very cost efficient, lamination film 38, which excels in very low thickness variation, optimal usage of different state of art barrier resins, very high mechanical strength and very high flex-crack resistance (avoiding micro pinholes).

The line 10 provides uninterrupted running of the main coating procedures with no down time because of purge procedures for changing on-and back to barrier resin co-extrusion in the coating stations. The line 10 provides a major improvement in net usable production hours. The fact that the extrusion coating line 10 can be running at the same location as the blown line, provides increased efficiency and avoids highly inefficient transportation of mother rolls of blown co-extruded barrier lamination film.

The laminate structure in the preferred embodiment provides a significantly improved EVOH-based barrier board 12, with the ability to use the blown film 38 as a mechanical support in the board structure because the choice of resins in blown film co-extrusion is at least 10 times higher than in extrusion coating, so that mechanically supportive resins can be used more readily. The result is thickness- and cost-reduction without loss of chemical and physical properties.

The production line 10 provides the ability to run newly available barrier resins like PGA (polyglycol alcohol) without additional purging. The production line 10 can be the platform for development of, for example, board versions that are based on non-oil based renewable polymers like PLA (polyalactic acid) and PGA (polyglycol alcohol) as well as extrusion lamination of state-of- the-art, high-barrier, coated oriented films; all of this development can be provided without significantly interfering with the day-to-day production of the coating line 10.

FIGS. 10 to 12 show further embodiments of the laminate structure 12. These Figures show different embodiments for the layer 32 provided by the extruder 30 of FIG. 1. These embodiments add temperature and abuse resistance properties to the layer 32. In older filling machines gas burners are used to heat the polymers prior to sealing of the container formed from the blank. The problem with such gas burner systems is that they overheat the barrier structure and can create pin holes in the outer layers of the structure. The improved layers 32 of these Figures protect the board and the external layer or layers 20 of the structure from the excess heat.

FIG. 10 shows the layer 32 being comprised of a blend of a polyolefin (LDPE), nylon (PA) and a compatibiliser (C). The nylon within the blend provides heat resistant properties to the layer 32. An alternative polyolefin to be used in the blend instead of the LDPE is polypropylene. The compatibiliser is a polymer which has affinity to both the nylon and the polyolefin and assists the formation of the blend between the other two polymers. Alternatively, the layer 32 could be in the form of a polyamide/polyolefin alloy, instead of a simple blended product. A further embodiment is shown in FIG. 11, in which the layer 32 is comprised of a blend of high density polyethylene and calcium carbonate. FIG. 12 shows a yet further embodiment, where the layer 32 is comprised of three sub-layers 70, 72 and 74. The board-facing layer 70 is comprised of nylon, the second sub-layer 72 is a tie layer comprised of a suitable polymer, and the third sub-layer 74 is a polyolefin. These three sub-layers 70, 72 and 74 are co-extrusion laminated when the film 26 is laminated to the board 16 at station 24 of FIG. 1.

We claim:

1-35. (canceled)

36. A method of producing a laminate structure comprising
producing a multi-layer barrier film by producing a blown film of n layers, by a blown extrusion process, and collapsing the n-layer blown film to form the multi-layer barrier film, which consists of 2n layers, and which comprises a first polymer layer, a gas barrier layer and a second polymer layer, wherein at least one of the first and second polymer layers comprises a polyamide layer,
providing a substrate, and
laminating the multi-layer barrier film to the substrate.

37. A method according to claim 36, wherein said laminating comprises extrusion laminating said film to said substrate by way of an adhesive layer.

38. A method according to claim 37, wherein said adhesive layer comprises polyamide.

39. A method according to claim 38, wherein said adhesive layer comprises either a polyamide sub-layer, a tie sub-layer and a polyolefin sub-layer, or a blend of polyamide, polyolefin and a compatibiliser.

40. A method according to claim 37, wherein said adhesive layer comprises a blend of high density polyolefin and calcium carbonate.

41. A method according to claim 37, wherein said structure has an inside surface and an outside surface relative to a product to be packaged thereby and said laminating is of said film to said inside surface.

42. A method according to claim 41, and further comprising applying an outer layer to said outside surface.

43. A method according to claim 42, wherein the outer layer is provided by a second multi-layer barrier film laminated to said outside surface of the substrate.

44. A method according to claim 43, wherein the second multi-layer barrier film is substantially identical to the first-mentioned barrier film.

45. A method according to claim 43, wherein, in the or each multi-layer barrier film, the first polymer layer, the gas barrier layer and the second polymer layer form a first barrier block, and the or each multi-layer barrier film further comprises a second barrier block, substantially identical to the first barrier block.

46. A method according to claim 36, wherein the or each gas barrier layer comprises an ethylene vinyl alcohol (EVOH) layer or a polyglycol alcohol (PGA) layer.

47. A method according to claim 36, wherein one of the first and second polymer layers of the or each multi-layer barrier film comprises a polypropylene layer.

48. A method according to claim 36, wherein one of the first and second polymer layers of the or each multi-layer barrier film comprises a polyolefin tie layer.

49. A method according to claim 36, wherein each of the first and second polymer layers of the or each multi-layer barrier film comprises a polyamide layer.

50. A method according to claim 36, wherein, in the or each multi-layer barrier film, the first polymer layer contacts the gas barrier layer and the gas barrier layer contacts the second polymer layer.

51. A method according to claim 36, wherein the n-layer blown film comprises, from the outside to the inside, a polymer layer, a tie layer, the first polymer layer which comprises a polyamide layer, the gas barrier layer which comprises an EVOH layer, the second polymer layer which comprises a polyamide layer, a tie layer and a polymer layer.

52. A laminate structure comprising, from the outside to the inside,
a substrate, and
a multi-layer barrier film comprising a 2n-layers film consisting of an n-layer blown film collapsed, the film including a first polymer layer, a gas barrier layer and a second polymer layer, wherein at least one of the first and second polymer layers comprises a polyamide layer.

53. A structure according to claim 52, and further comprising an adhesive layer between said substrate and said film.

54. A structure according to claim 53, wherein said adhesive layer comprises polyamide.

55. A structure according to claim 54, wherein said adhesive layer comprises either a polyamide sub-layer, a tie sub-layer and a polyolefin sub-layer, or a blend of polyamide, polyolefin and a compatibiliser.

56. A structure according to claim 53, wherein said adhesive layer comprises a blend of high density polyolefin and calcium carbonate.

57. A structure according to claim 52, and further comprising an outer layer on the outside of said substrate.

58. A structure according to claim 57, wherein the outer layer is provided by a second multi-layer barrier film.

59. A structure according to claim 58, wherein the second multi-layer barrier film is substantially identical to the first-mentioned barrier film

60. A structure according to claim 58, wherein, in the or each multi-layer barrier film, the first polymer layer, the gas barrier layer and the second polymer layer form a first barrier block, and the or each multi-layer barrier film further comprises a second barrier block, substantially identical to the first barrier block.

61. A structure according to claim 52, wherein the or each gas barrier layer comprises an ethylene vinyl alcohol (EVOH) layer or a polyglycol alcohol (PGA) layer.

62. A structure according to claim 52, wherein, in the or each multi-layer barrier film, one of the first and second polymer layers comprises a polypropylene layer.

63. A structure according to claim 52, wherein, in the or each multi-layer barrier film, one of the first and second polymer layers comprises a polyolefin tie layer.

64. A structure according to claim 52, wherein, in the or each multi-layer barrier film, each of the first and second polymer layers comprises a polyamide layer.

65. A structure according to claim 52, wherein, in the or each multi-layer barrier film, the first polymer layer contacts the gas barrier layer and the gas barrier layer contacts the second polymer layer.

66. A structure according to claim 52, wherein the n-layer blown film comprises, from the outside to the inside, a polymer layer, a tie layer, the first polymer layer which comprises a polyamide layer, the gas barrier layer which comprises an EVOH layer, the second polymer layer which comprises a polyamide layer, a tie layer and a polymer layer.

67. A laminate structure comprising, from the outside to the inside,
a substrate, and
a multi-layer barrier film comprising a first polymer layer, a gas barrier layer and a second polymer layer, wherein at least one of the first and second polymer layers comprises a polypropylene layer.

68. A method comprising, at a laminating station on a production line for a laminate structure, laminating together (i) a multi-layer barrier film comprising a first polymer layer, a gas barrier layer and a second polymer layer, wherein at least one of the layers comprises a polyamide, and (ii) a substrate, and, subsequently, laminating together at said station a substrate and another multi-layer barrier film differing from the first-mentioned film.
